(19) United States
(12) Patent Application Publication
(10) Pub. No.: US 2004/0239638 A1
(43) Pub. Date: Dec. 2, 2004

(54) System and method for displaying, completing and executing keyboard key combinations

(75) Inventors: Scott R. Swanson, Redmond, WA (US); Michael J. Arnquist, Woodinville, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/452,348

(22) Filed: Jun. 2, 2003

(51) Int. Cl. G09G 5/00

(52) U.S. Cl. 345/172

(57) ABSTRACT

When a keystroke is detected where the detected keystroke is part of a combination of keystrokes that represents a keyboard key combination, a list may be displayed. The list may include a list of subsequent key command modifiers available for the detected keystroke. The list may be displayed so that the list does not obscure the area of focus or the active process display, or reduces the amount of the active process display that is obscured. The key combination can be selected by various methods. If no response is received within a pre-determined time period, the list may be removed from the display screen.

### FIELD OF THE INVENTION

The invention relates to user interfaces and in particular to using keyboard key combinations.

### BACKGROUND OF THE INVENTION

When using a computer, it is frequently helpful to have one or more keyboard key combinations to perform frequently-used tasks. A keyboard key combination is a combination of keystrokes that can be used to perform a task, instead of, for example, using a mouse to select an option from a menu. One commonly used keyboard key combination both in MICROSOFT WINDOWS and in APPLE MACINTOSH operating systems, is CONTROL+S which saves a file.

One major advantage of using keyboard key combinations is that the user does not have to remove his hand from the keyboard to manipulate the mouse. This saves time and may avoid keyboarding errors resulting from, for example, mis-positioning the hand when the hand is replaced over the keyboard after the mouse manipulation process is complete. One can imagine that such a helpful feature would encourage creation of quite a number of keyboard key combinations.

Programmers and developers are often extensive users of keyboard key combinations and often use the same key combination to mean different things. For example, CONTROL+O may mean “OPEN FILE” in one programming language and “OPEN PROJECT” in another. Similarly, the keyboard key combination required to execute a command may be different depending on the context in which it is used. For example, to bring up a particular tool window from one programming language editor may require entering the key combination “CONTROL+r” while bringing up the same tool window may require entering the key combination “CONTROL+ALT+l” in another programming language editor. It can become quite difficult to keep track of what command a particular key combination is bound to within the current context, and to remember all the different key combinations.

It would be helpful if there would be some way to make it easier to use keyboard key combinations.

### SUMMARY OF THE INVENTION

A system, method and computer-readable medium containing instructions for visually displaying current key combinations mapped to commands within the current context is described. When a keystroke is detected where the detected keystroke is part of a combination of keystrokes that represents a keyboard key combination, a list may be displayed. The list may include a list of subsequent key command modifiers available for the detected keystroke. Alternatively, the list may include complete keyboard key combinations mapped to commands active within the process context. The list may be displayed so that the list does not obscure the area of focus or the active process display, or reduces the amount of the active process display that is obscured. The list may include only those key combinations which are modifiers of the detected key combination keystroke. The key combination can be selected by various methods, such as by pressing the key modifier, by selecting from the displayed list with the mouse or other cursor manipulator or by selecting the list element via the keyboard (e.g., using the arrow keys). If no response is received within a predetermined time period, the list may be removed from the display screen.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 is a block diagram of a system for displaying, completing and executing keyboard key combinations in accordance with one embodiment of the invention;

FIG. 3a is a screen shot of an exemplary keyboard key combination display in accordance with one embodiment of the invention;

FIG. 3b is a screen shot of an exemplary keyboard key combination display in accordance with another embodiment of the invention;

FIG. 4 is a flow diagram of a method of displaying, completing and executing keyboard key combinations in accordance with one embodiment of the invention.

### DETAILED DESCRIPTION OF ILLUSTRATIVE EMBODIMENTS

Overview

When a keystroke is detected where the detected keystroke is part of a combination of keystrokes that represents a keyboard key combination, a list of current keyboard key combinations and the commands to which they are mapped within the process context may be displayed. For example, suppose a user knows that there is a keyboard key combination for “cut” or “delete” and knows that part of the key combination is pressing the “CONTROL” key. By pressing the “CONTROL” key, a list of keyboard key combinations that include “CONTROL” may be displayed. The displayed list may be filtered so that only key combinations containing the received keystroke are included. In the above example, that would mean only key combinations that include pressing the “CONTROL” key will be displayed; so that, for example, key combinations such as SHIFT+x will not appear on the list while key combinations such as “CONTROL+a” and “CONTROL+x” and “SHIFT+CONTROL” will appear on the list. Alternatively, the displayed list may be filtered so that only key combinations that begin with the pressed partial key combination are displayed. That is, if the user presses “ALT” and the key combination is “CONTROL+ALT+O”, the displayed list will include “ALT+O” and “ALT+x” but will not include “CONTROL+ALT+O”.

If the key combination is a chord, that is, is comprised of a sequence of keyboard key combinations such as, for example, “CONTROL+k” followed by “CONTROL+m”, the displayed list may include the first modifier or may also display the second modifier. For example, suppose the entire keyboard key combination for a particular command is “CONTROL+k, CONTROL+m” while a second command is initiated by the sequence “CONTROL+k, CONTROL+k”. Suppose the user presses “CONTROL”. At this point, the displayed list may display only the single keyboard key combinations that begin with “CONTROL”, hence the displayed list may include:“CONTROL+a”, CONTROL+k”, and “CONTROL+x”. If the user selects “CONTROL+k” or keys in “k”, he may be presented with the list “CONTROL+k” and CONTROL+m”. Alternatively, the list displayed when the user enters “CONTROL”, may include the single keyboard key combinations and the chord key combinations that begin with “CONTROL”, so that the displayed list would include ““CONTROL+a”, CONTROL+k”, “CONTROL+x”, “CONTROL+k, CONTROL+k”, and “CONTROL+k, CONTROL+m”.

The list may be displayed so that the list does not obscure the area of focus or the active process display, or reduces the amount of the area of focus or active process display that is obscured. The list may include keyboard key combinations associated with one or more processing contexts. Each processing context may be associated with one or more keyboard key combination scopes.

The key combination can be selected by various methods, such as by pressing the key modifier, by selecting from the displayed list with the mouse or other cursor manipulator, or by selecting the list element via the keyboard (e.g., using the arrow keys). If no response is received within a pre-determined time period, the list may be removed from the display screen.

Exemplary Computing Environment

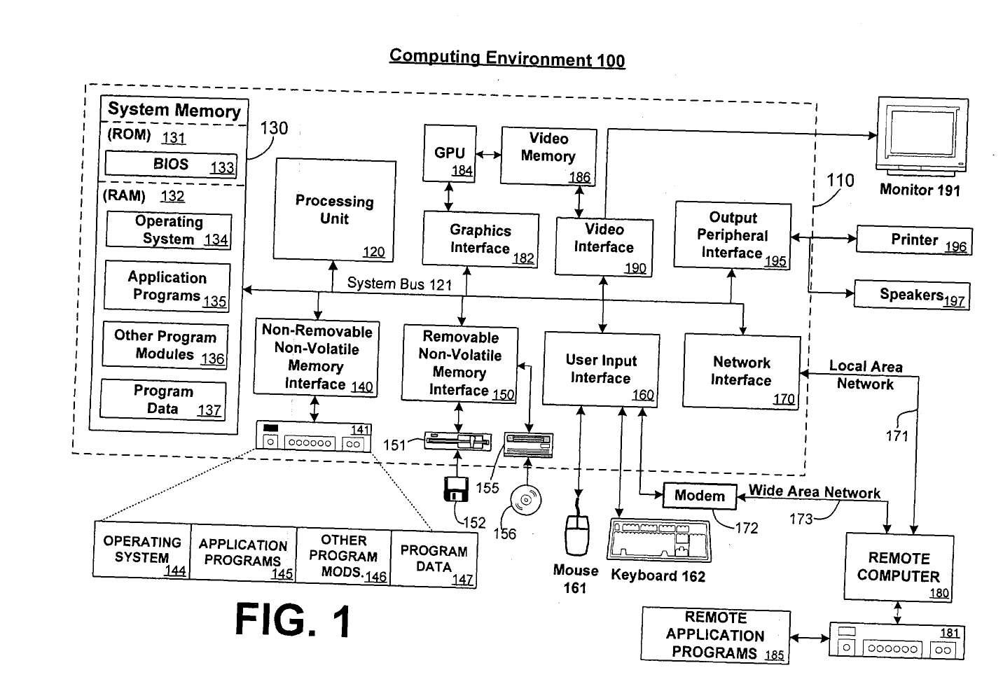

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1a illustrates operating system 134, application programs 135, other program modules 136, and program data 137.

The computer 110 may also include other removable/non-removable, volatile/nonvolatile computer storage media. By way of example only, FIG. 1a illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1a. The logical connections depicted in FIG. 1a include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1a illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

System and Method for Displaying, Completing and Executing Keyboard Key Combinations

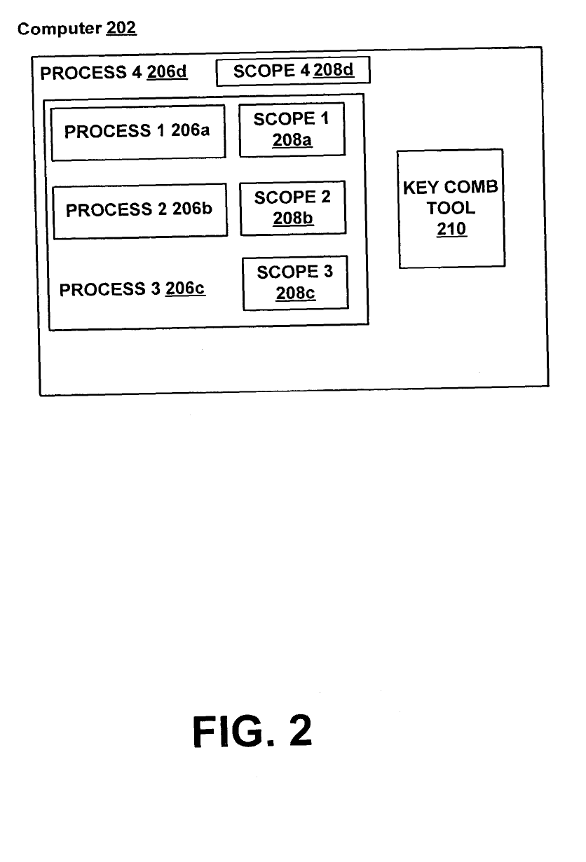

FIG. 2 illustrates an exemplary system for displaying, completing and executing keyboard key combinations in accordance with one embodiment of the invention. Referring now to FIG. 2, computer 202 represents a computer on which the invention may reside. The invention may be implemented as a component of an environment in which one or more processes executes concurrently, or substantially concurrently, or as a stand-alone system for use with one or more processes. The invention may include a component or tool 210 for displaying, completing and executing keyboard key combinations within one or more processing contexts. Each processing context may be associated with one or more keyboard key combination scopes.

For example, FIG. 2 represents one possible environment in which the invention may be practiced, process 4 206d associated with keyboard key combination scope 208d hosts or includes one or more processes such as for example, process 1 206a, process 2 206b, process3, 206c and so on. One or more of these processes, that is process 1 206a, process 2206b, process 3, 206c, etc. may run within another process. For example, as shown in FIG. 2, process 3 206c hosts process 1 206a and process 2 206b and process 4 206d hosts process 1 206a, process 2 206b and process 3 206c. Of course it will be understood that the invention as contemplated is not so limited-any suitable configuration of hosted/hosting processes is possible.

Processes 1 206a, 2 206b, 3 206c, and process 4 206d may represent any suitable process in which a list of keyboard key combinations might be helpful, such as for example, a design developer, an editor, a compiler, a language service, a dynamic parser, a programming tool, a browser, an e-mail handler or any other process for which key combinations may be helpful.

Process 1 206a may be associated with keyboard key combination scope 208a, process 2 206b may be associated with keyboard key combination scope 208b and process 3 206c may be associated with keyboard key combination scope 208c and so on. As above, it will be understood that the invention as contemplated is not so limited-for example, process 1 206a may be associated with more than one keyboard scope or may be associated only with a global keyboard key combination scope. A keyboard key combination scope 208d associated with process 4 206d may, for example, be a global scope. Similarly, because process 1 206a is embedded in process 3 206c, process 1 206a may also be associated with the keyboard key combination scope 208c associated with process 3 206c.

Furthermore, process 1 206a, process 2 206b, etc. may be associated with additional keyboard key combination scopes, such as, for example, a user-specified (e.g., a personal or customized) scope.

Scopes may be effective in a hierarchical fashion, that is: suppose, for example, an execution environment comprises a design environment in which a global scope maps the keyboard key combination CONTROL+O to a “File Open” command. Suppose further that the active window in the design environment is a MICROSOFT VISUAL BASIC program editor associated with a scope that maps the keyboard key combination CONTROL+O to a “Project Open” command. In this case, the global key combination may be over-ridden by the scope associated with the hosted process so that within the VISUAL BASIC program editor the keyboard key combination CONTROL+O maps to a “Project Open” command. It will be understood that the hierarchy of scope dominance is not limited to two scopes. For example, a user may have a third user-specified or customized scope which in one embodiment of the invention, overrides all other scopes, and so on.

Non-overlapping key combination mappings of a hosted process may be added to the mappings of the global scope, and so on. For example, suppose now that a global scope maps CONTROL+O to a “File Open” command and a C++ scope maps CONTRL+Y to a delete line command. In this case, there is no overlap between command mappings so the global CONTROL+O key combination would not be overridden.

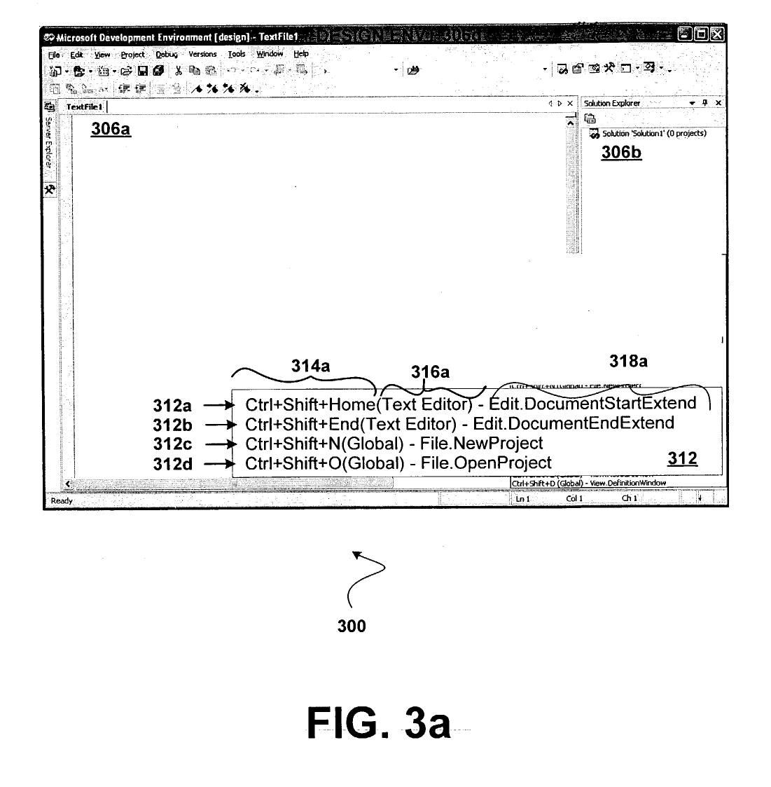

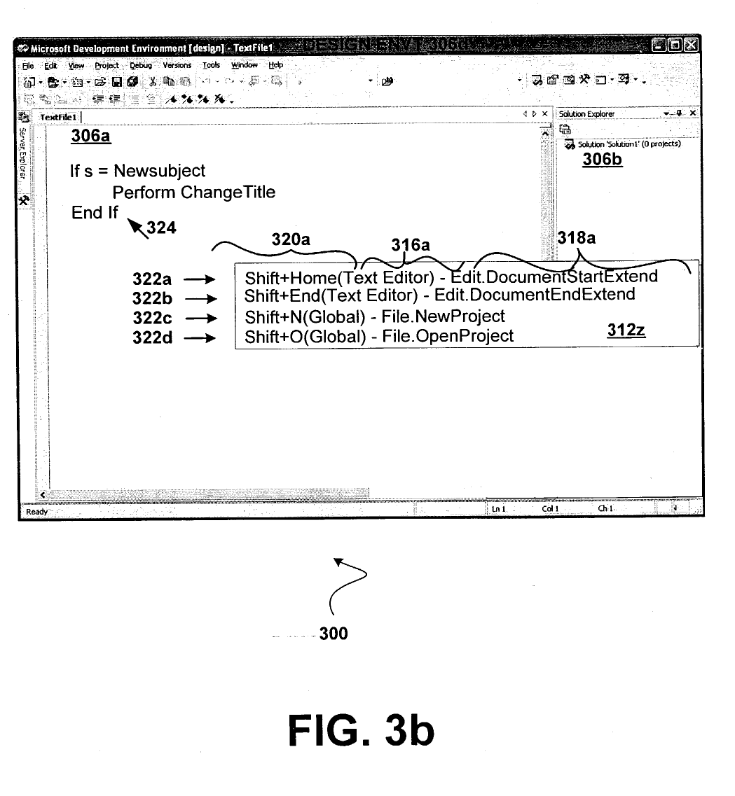

FIGS. 3a and 3b are screen shots of exemplary user display interfaces in accordance with one embodiment of the invention, in which process 4 206d, with which key combination component 210 is associated, is represented by design environment 306d, a development environment, such as, for example, MICROSOFT VISUAL STUDIO or BORLAND C++ BUILDER or any other development environment. Within design environment 306d, two exemplary processes are running, here represented by text editor user interface 306a and programming tool user interface 306b.

Keyboard key combination display list 312 is triggered by key combination component/tool 210 receiving one of a predetermined list of triggering keystrokes. The triggering keystroke may include several keys pressed at the same time or a particular sequence of keystrokes. A list of keyboard key combinations is generated and displayed by key combination tool 210. It will be noted that keyboard key combination display list 312 is located in the lower right corner of user interface display 300. In one embodiment of the invention, key combination display list 312 is located in such a way so that the amount of text obscured by key combination display list 312 is reduced or minimized. The amount of text obscured by key combination display list 312 is reduced or minimized by noting the focus in the display (such as, for example, by noting the current active display area and positioning the key combination display list 312 so that the list 312 overlays the current active display area as little as possible, such as by placing the list 312 in the lower right position of the display 300 as shown in FIG. 3a. Similarly, the amount of text obscured by key combination display list 312 may be reduced or minimized by noting the current position of the cursor 324 and locating the list 312 to the left or right or above or below the cursor, depending on where in the screen display 300 the cursor is currently located, as shown in FIG. 3b.)

Keyboard key combination display list 312 may display the key combinations associated with the process user interfaces displayed in display 300. The keyboard key combination list may display one or more keyboard key combination list members. For example, in FIG. 3a, exemplary keyboard key combination list members 312a, 312b, 312c and 312d are included in keyboard key combination list 312, although any suitable number of key combinations list members may be displayed. Keyboard key combinations list members as exemplified by keyboard key combination list members 312a, 312b, 312c and 312d, may be comprised of three or more parts. As shown in FIG. 3a, keyboard key combination list member 312a includes three parts, a keyboard key combination 314a, the scope 316a with which the keyboard key combination 314a is associated and the command 318a to which the keyboard key combination 314a is mapped. So, for example, in keyboard key combination 312a comprising “Ctrl+Shift+Home(Text Editor)—Edit.DocumentStartExtend”, the keyboard key combination is “Ctrl+Shift+Home”, the scope and process with which the key combination is associated is “Text Editor” and the command to which the key combination maps is the command “Edit.DocumentStartExtend”. Keyboard key combination display list 312 may be a scrollable list, so that the amount of active display space overlaid by the list 312 is reduced or minimized.

When the display of the keyboard key combination list is triggered by the detection of the input of a keystroke where the detected keystroke is part of a combination of keystrokes that represents a keyboard key combination, a list of current keyboard key combination modifiers and the commands to which they are bound within the process context may be displayed, as illustrated in FIG. 3b. For example, suppose a user knows that there is a keyboard key combination for “cut” or “delete” and knows that part of the key combination is pressing the “CONTROL” key. By pressing the “CONTROL” key, a list of keyboard key combination modifiers of “CONTROL” may be displayed. The displayed list may be filtered so that only key combinations that include pressing the “CONTROL” key are displayed; that is, for example, key combinations such as SHIFT+x will not appear on the list while key combinations such as “CONTROL+a” and “CONTROL+x” and “SHIFT+CONTROL” will appear on the list. Alternatively, the displayed list may be filtered so that only key combinations that begin with the pressed partial key combination are displayed. That is, if the user presses “ALT” and the key combination is “CONTROL+ALT+O”, the displayed list will include “ALT+O” and “ALT+x” but will not include “CONTROL+ALT+O”. Alternatively, only the modifiers “a”, “x” may appear followed by the command to which they are mapped.

As illustrated in FIG. 3b, keyboard key combination display list 312z may display the partial key combinations associated with the process user interfaces displayed in display 300. The keyboard key combination list may display one or more partial keyboard key combination list members. For example, in FIG. 3b, exemplary partial keyboard key combination list members 322a, 322b, 322c and 322d are included in partial keyboard key combination list 312z, although any suitable number of partial key combinations list members may be displayed. Partial keyboard key combinations list members, as exemplified by partial keyboard key combination list members 322a, 322b, 322c and 322d, may be comprised of three or more parts. As shown in FIG. 3b, partial keyboard key combination list member 322a includes three parts, a partial keyboard key combination 320a, the scope 316a with which CONTROL+ the partial keyboard key combination 320a is associated and the command 318a to which CONTROL+ the partial keyboard key combination 320a is mapped. So, for example, in partial keyboard key combination 322a comprising “Shift+Home(Text Editor)—Edit.DocumentStartExtend”, the complete keyboard key combination is “Ctrl+Shift+Home”, the scope and process with which the key combination is associated is “Text Editor” and the command to which the key combination maps is the command “Edit.DocumentStartExtend”. Keyboard key combination display list 312z may be a scrollable list, so that the amount of active display space overlaid by the list 312z is reduced or minimized.

If the key combination is a chord, that is, is comprised of a sequence of keyboard key combinations such as, for example, “CONTROL+k” followed by “CONTROL+m”, the displayed list may include the first modifier or may also display the second modifier.

For example, suppose the entire keyboard key combination for a particular command is “CONTROL+k, CONTROL+m” while a second command is initiated by the sequence “CONTROL+k, CONTROL+k”. Suppose the user presses “CONTROL”. At this point, the displayed list may display only the single keyboard key combinations that begin with “CONTROL”, hence the displayed list may include: “CONTROL+a”, CONTROL+k”, and “CONTROL+x”. If the user selects “CONTROL+k” or keys in “k”, he may be presented with the list ““CONTROL+k” and CONTROL+m”. Alternatively, the list displayed when the user enters “CONTROL”, may include the single keyboard key combinations and the chord key combinations that begin with “CONTROL”, so that the displayed list would include ““CONTROL+a”, CONTROL+k”, “CONTROL+x”, “CONTROL+k, CONTROL+k”, and “CONTROL+k, CONTROL+m”.

In addition to the above described information, information associated with the scope from which the key combination originates may also be displayed. For example, referring now to FIGS. 3a and 3b, an indication of the process, such as “Text Editor” 314a, associated with the key combination, may also be displayed.

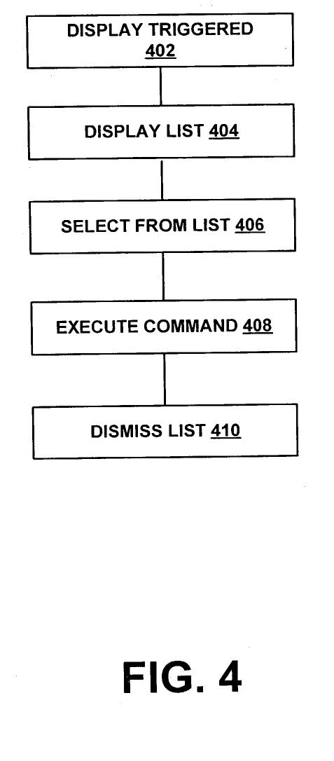

FIG. 4 is a flow chart of an exemplary method for displaying, completing and executing keyboard key combinations. In step 402 the key combination display list is triggered. The display of the key combination list may be triggered by entering a particular character or sequence of characters or by selecting a menu option, by right-clicking and selecting from a menu or by any other predetermined action. In one embodiment of the invention, the keyboard key combination list is not displayed until some predetermined period of time has passed with no further keystroke entry, so that the feature is not an annoyance to users who do not want such a list to appear.

If no means for filtering the display has been provided the entire list or scrollable partial list of available key combinations may be displayed. Alternatively, the list may be filtered as described above. In addition to the above filtering process, the list may also be filtered so that only enabled commands are displayed. Alternatively, disabled commands may be displayed but may be grayed out so that selection of a disabled command is not permitted.

At step 404 the keyboard key combination list as described above is displayed. The key combination list may be filtered in any of the ways described above, or a complete list may be displayed.

At step 406 a selection is made. In one embodiment of the invention, a keyboard key combination is selected by visual inspection of the keyboard key combination display list and entering the remaining portion of the keyboard key combination that maps to the desired command. For example, referring again to FIGS. 3a and 3b, suppose a user has triggered the display of a keyboard key combination display list or partial keyboard key combination display list. Suppose the user wants to execute the command “File.NewProject”, which is mapped to the keyboard key combination “CONTROL+SHIFT+N”. By pressing “CONTROL+SHIFT+N” or “SHIFT+N” respectively, the command “File.NewProject” will be executed.

Alternatively entry “CONTROL+SHIFT+N(Global)—File.NewProject” or “SHIFT+N(Global)—File.NewProject” may be selected by manipulating the cursor so the appropriate entry is highlighted or selected and pressing enter or clicking or activating the cursor manipulation device. Alternatively, entry “CONTROL+SHIFT+N(Global)—File.NewProject” or “SHIFT+N(Global)—File.NewProject may be selected by using the keyboard to navigate to the appropriate entry in the keyboard key combination display list and pressing enter or clicking with the cursor manipulation device. At step 408 the command is executed.

At step 410, the keyboard key combination display list is dismissed. The keyboard key combination display list may be dismissed either because a key combination has been selected or because a predetermined keystroke (e.g., pressing the ESCAPE key) dismisses the list display Alternatively, if no keystrokes or cursor manipulator input are received for a threshold period of time, (e.g., 5 seconds) the display list may be dismissed. In one embodiment of the invention, the feature can be turned on or off by means of setting a profile switch or an option in a menu.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

What is claimed is:

1. A method for displaying key combinations mapped to commands comprising:
in response to receiving a triggering event, displaying a list comprising at least one member, the at least one member comprising at least one part of a key combination mapped to a command within a process context, the command, and a scope associated with the key combination and the process context;
receiving an indication that the at least one member has been selected; and
executing the command.

2. The method of claim 1, wherein the triggering event comprises entering a predetermined keystroke sequence.

3. The method of claim 1, wherein the triggering event is receiving a first keystroke of a combination of keystrokes comprising the key combination mapped to the command.

4. The method of claim 1, wherein the at least one part of the key combination displayed in the list is a complete key combination mapped to the command.

5. The method of claim 1, wherein the list comprises a plurality of members associated with the process context.

6. The method of claim 1, wherein the list comprises a complete list of available key combinations available within the process context.

7. The method of claim 1, wherein the list is scrollable.

8. The method of claim 1, wherein the command is an enabled command within the process context.

9. The method of claim 1, wherein the process is a first process associated with a first set of key combinations associated with a first scope and a first set of commands to which the first set of key combinations are mapped, the first process hosted by a second process, the second process associated with a second set of key combinations associated with a second scope and a second set of commands.

10. The method of claim 9, wherein the displayed list comprises the first set of key combinations, the first scope and the first set of commands.

11. The method of claim 9, wherein the displayed list comprises the second set of key combinations, the second scope and the second set of commands.

12. The method of claim 1, wherein the list is displayed so as to reduce the amount of process interface obscured by the list.

13. The method of claim 12, wherein the list is displayed in a lower right hand corner of a display window comprising at least one process interface.

14. The method of claim 12, wherein the list is displayed in a position above and not overlaying a current cursor position.

15. The method of claim 12, wherein the list is displayed in a position below and not overlaying a current cursor position.

16. The method of claim 12, wherein the list is displayed in a position adjacent and not overlaying a current cursor position.

17. The method of claim 12, wherein a display window comprises a first process interface and a second process interface, and wherein the first process interface is active, displaying the list in the second process interface.

18. The method of claim 1, wherein a member of the list is selected by pressing the partial key combination displayed in the list member.

19. The method of claim 1, wherein a member of the list is selected by navigating to the list member via one or more keys on a keyboard.

20. The method of claim 1, wherein a member of the list is selected by using a cursor manipulator to select the list member.

21. The method of claim 1, wherein the list is dismissed after a specified period of time has elapsed without keystroke input.

22. A system for displaying a list of key combinations mapped to commands comprising:
a component for receiving a triggering event, displaying a list comprising at least one member, the at least one member comprising at least one part of a key combination mapped to a command within a process context, the command, and a scope associated with the key combination and the process context, receiving an indication that the at least one member has been selected; and executing the active command of the at least one member.

23. The system of claim 22, wherein the component is part of an integrated design environment.

24. The system of claim 22, wherein the component is a first component in the integrated design environment and the integrated design environment further comprises at least a second component, the second component comprising an editor, a compiler, a browser, an email handler, a programming tool or a dynamic parser.

25. The system of claim 22, wherein the second component is associated with a firstscope of key combinations mapped to commands.

26. The system of claim 25, further comprising a third component associated with a second scope of key combinations mapped to commands.

27. The system of claim 26, wherein a hierarchy of scopes is recognized, such that the first scope overrides the second scope.

28. The system of claim 26, wherein the second component is currently active.

29. The system of claim 26, wherein the second component is hosted by the third component.

30. A computer-readable medium comprising computer-executable instructions for:
in response to receiving a triggering event, displaying a list comprising at least one member, the at least one member comprising at least one part of a key combination mapped to a command within a process context, the command, and a scope associated with the key combination and the process context;
receiving an indication that the at least one member has been selected; and
executing the active command of the at least one member.
